(19) United States
(12) Patent Application Publication
(10) Pub. No.: US 2026/0204651 A1
(43) Pub. Date: Jul. 16, 2026

(54) LITHIUM METAL BATTERY, METHOD OF PREPARING THE SAME, AND LITHIUM METAL BATTERY MODULE INCLUDING THE SAME LITHIUM METAL BATTERY AS UNIT CELL

(71) Applicant: Samsung Electronics Co., Ltd., Suwon-si, Gyeonggi-do (KR)

(72) Inventors: Victor ROEV, Suwon-si (KR); Hwiyeol Park, Suwon-si (KR)

(21) Appl. No.: 19/443,106

(22) Filed: Jan. 8, 2026

(30) Foreign Application Priority Data
Jan. 13, 2025 (KR) 10-2025-0004985

(51) Int. Cl. H01M 10/0585; H01M 10/052; H01M 10/0562; H01M 10/0565; H01M 10/0568; H01M 10/0569; H01M 10/42

(52) U.S. Cl. CPC H01M 10/0585; H01M 10/052; H01M 10/0562; H01M 10/0565; H01M 10/0568; H01M 10/0569; H01M 10/4235; H01M 2300/0034; H01M 2300/0071; H01M 2300/0082; H01M 2300/0085; H01M 2300/0094

(57) ABSTRACT

A lithium metal battery, a method of preparing the lithium metal battery, and a lithium metal battery module including the lithium metal battery as a unit cell. The lithium metal battery includes an anode layer including lithium metal or a lithium alloy, a solid electrolyte layer on the anode layer, and a cathode layer on the solid electrolyte layer, and further includes an interlayer-containing region and an interlayer-free region between the anode layer and the solid electrolyte layer, wherein the interlayer-containing region includes an interlayer including a carbon-containing material, and the interlayer-free region includes at least one of a liquid electrolyte, a gel electrolyte, or a polymer electrolyte.

### CROSS-REFERENCE TO RELATED APPLICATION

This application is based on and claims priority to Korean Patent Application No. 10-2025-0004985, filed on Jan. 13, 2025, in the Korean Intellectual Property Office, and all the benefits accruing therefrom under 35 U.S.C. § 119, the content of which is incorporated by reference herein in its entirety.

### BACKGROUND

### 1. Field

The present disclosure relates to a lithium metal battery, a method of preparing the lithium metal battery, and a lithium metal battery module including the lithium metal battery as a unit cell.

### 2. Description of the Related Art

Lithium metal batteries employing a solid electrolyte instead of a flammable organic solvent electrolyte are attracting much attention in the development of batteries with high energy density and safety. Lithium metal batteries use lithium metal or a lithium alloy as an anode layer, or employ a method wherein an anode active material layer is not formed on an anode current collector.

Generally, lithium metal batteries are manufactured using cold isostatic pressing (CIP) and/or warm (or hot) isostatic pressing (WIP). However, in lithium metal batteries manufactured by such methods, gap regions or voids form between the anode layer and the solid electrolyte layer after assembly due to the high pressure and low- or high-temperature conditions. As a result, the interfacial resistance between the anode layer and the solid electrolyte layer increases, and the charge-discharge characteristics deteriorate.

Therefore, there is a need for a lithium metal battery in which charge-discharge characteristics can be improved by lowering interfacial resistance and improving contact between the anode layer and the solid electrolyte layer, a method of manufacturing the same, and a lithium metal battery module including the lithium metal battery as a unit cell.

### SUMMARY

An aspect provides a lithium metal battery having low charge transfer resistance between a solid electrolyte layer and an anode layer and improved critical current density and areal capacity.

Another aspect provides a method for manufacturing the lithium metal battery.

Another aspect provides a lithium metal battery module including the lithium metal battery as a unit cell.

Additional aspects will be set forth in part in the description which follows and, in part, will be apparent from the descript ion, or may be learned by practice of the presented embodiments of the disclosure.

According to an aspect, a lithium metal battery includes:
an anode layer including lithium metal or a lithium alloy;
a solid electrolyte layer on the anode layer; and
a cathode layer on the solid electrolyte layer,
further including, an interlayer-containing region and an interlayer-free region between the anode layer and the solid electrolyte layer,
wherein the interlayer-containing region includes an interlayer including a carbon-containing material, and
the interlayer-free region includes at least one of a liquid electrolyte, a gel electrolyte, or a polymer electrolyte.

According to another aspect, a method of preparing a lithium metal battery includes:
mixing, with a binder, at least one carbon-containing material comprising a carbon material, a carbon composite, or a combination thereof, to prepare an interlayer-forming composition;
applying and drying the interlayer-forming composition on a first surface of the solid electrolyte, at a coverage of about 30% to about 99.9% based on a total surface area of the first surface, thereby forming an interlayer on the surface of the solid electrolyte;
contacting at least one of a liquid electrolyte, a gel electrolyte, or a polymer electrolyte with a surface of the solid electrolyte layer on which the interlayer is not formed;
placing an anode layer on the first surface of the solid electrolyte layer on which the interlayer formed, and on the surface of the solid electrolyte layer that is in contact with the at least one of the liquid electrolyte, the gel electrolyte, or the polymer electrolyte; and
placing a cathode layer on a second surface of the solid electrolyte layer on which the anode layer is placed.

According to another aspect, a lithium metal battery module including a lithium metal battery as a unit cell includes:
an anode layer including lithium metal or a lithium alloy;
a solid electrolyte layer on the anode layer; and
a cathode layer on the solid electrolyte layer,
further including an interlayer-containing region and an interlayer-free region between the anode layer and the solid electrolyte layer,
wherein the interlayer-containing region includes an interlayer including a carbon-containing material, and
at least a portion of the interlayer-free region includes at least one of a liquid electrolyte, a gel electrolyte, or a polymer electrolyte.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an anode layer/interlayer/solid electrolyte layer structure of a lithium metal battery in an initial or fully discharged state, according to an embodiment;

FIG. 1B illustrates an anode layer/interlayer/solid electrolyte layer structure of a lithium metal battery in an initial or fully discharged state, according to another embodiment;

FIG. 2 illustrates a Nyquist plot showing imaginary impedance Z″ (Ohm, Ω) versus real impedance Z′ (Ohm, Ω) of electrochemical impedance test results for lithium metal batteries prepared in Example 1, Example 2, and Comparative Example 1;

FIG. 3A illustrates a graph showing voltage (voltage, v) versus areal capacity (milliamperes-hour per square centimeter, mAh/cm²) of charge-discharge test results for a lithium metal battery prepared in Example 1;

FIG. 3B illustrates a graph showing voltage (voltage, v) versus areal capacity (milliamperes-hour per square centimeter, mAh/cm²) of charge-discharge test results for a lithium metal battery prepared in Example 2; and

FIG. 3C illustrates a graph showing voltage (voltage, v) versus areal capacity (milliamperes-hour per square centimeter, mAh/cm²) of charge-discharge test results for a lithium metal battery prepared in Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list, and includes a combination of one or more of the elements.

The present inventive concept described below may be subject to various modifications and may have various embodiments, and specific embodiments are illustrated in the drawings and described in detail in the detailed description. However, this is not intended to limit the present inventive concept to specific embodiments, and should be understood to include all modifications, equivalents, or substitutes included within the technical scope of the present inventive concept.

The terminology used herein is for the purpose of describing particular embodiments only and is not intended to be limiting of the present inventive concept. As used herein, the singular forms are intended to include the plural forms as well, unless the context clearly indicates otherwise.

In the present specification, the expression “at least one,” or “one or more,” preceding a list of elements does not mean that it supplements the entire list of elements nor that it supplements the individual elements of the description. In the present specification, the term “combination,” unless otherwise specified, includes mixtures, alloys, reaction products, and the like. In the present specification, the term “comprising,” or “including”, unless otherwise specified, means that other components may be further included, not excluding other components. In the present specification, terms such as “first” and “second” are used to distinguish one element from another, and do not indicate order, quantity, or importance. Unless otherwise indicated herein or clearly contradicted by context, it should be interpreted to include both singular and plural forms. “Or,” unless otherwise specified, means “and/or”.

Throughout the present specification, “an embodiment,” “embodiment,” and the like mean that a particular element described in connection with the embodiment is included in at least one embodiment described in the present specification and may or may not be present in other embodiments. Furthermore, it should be understood that the described elements may be combined in any suitable manner in various embodiments. Unless otherwise stated, all percentages, parts, ratios, etc., are by weight. Also, when a quantity, concentration, or other value or parameter is given as either a range, preferred range, or a list of preferred upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is referred to herein, unless otherwise stated, the range is intended to include the endpoints thereof, and all integers and fractions within the range. The scope of the present disclosure is not intended to be limited to the specific values recited when defining a range.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise specified, the unit “parts by weight” refers to the weight ratio between each component, and the unit “parts by mass” refers to the value obtained by converting the weight ratio between each component to solid content.

As used herein, “about” includes the stated value and means within an acceptable range of deviation for the particular value as determined by one of ordinary skill in the art, considering the measurement in question and the error associated with measuring the particular quantity (i.e., the limitations of the measurement system). For example, “about” can mean within one or more standard deviations, or within ±30%, 20%, 10%, 5, or 3% of the specified value.

As used herein, the term “absent” indicates that a particular element, compound, material, or condition is not present in the described invention, composition, or method, either entirely or to a degree that is functionally negligible.

Unless otherwise defined, all terms (including technical and scientific terms) used herein have the same meaning as commonly understood by one of ordinary skill in the art to which this disclosure belongs. Furthermore, it will be understood that terms, such as those defined in commonly used dictionaries, should be interpreted as having a meaning that is consistent with their meaning in the context of the relevant art and the present disclosure, and will not be interpreted in an idealized manner. Or these terms should not be interpreted in an overly formal sense.

Exemplary embodiments are described herein with reference to cross-sectional illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions illustrated herein but are to include deviations in shapes that result, for example, from manufacturing. For example, a region illustrated or described as flat may, typically, have rough and/or nonlinear features. Also, angles illustrated as sharp may be rounded. Thus, the regions illustrated in the figures are schematic in nature and their shapes are not intended to illustrate the precise shape of a region and are not intended to limit the scope of the claims.

Generally, lithium metal batteries are manufactured through a pressing step and a heat treatment step using cold isostatic pressing (CIP) and/or warm (or hot) isostatic pressing (WIP). As a result, all interfacial regions between the anode layer and the solid electrolyte layer cannot maintain good contact, resulting in gap regions or voids between the anode layer and the solid electrolyte layer. Therefore, the charge-discharge characteristics of the lithium metal battery deteriorate.

Furthermore, oxide solid electrolytes have a brittle nature. Therefore, if a lithium metal battery including an oxide solid electrolyte is manufactured using CIP and/or WIP, such a lithium metal battery is susceptible to damage.

The inventors of the present disclosure have addressed the aforementioned issues and propose a lithium metal battery having a new structure applicable to various solid electrolyte layers including oxide-containing solid electrolytes, a method of preparing lithium metal battery, and a lithium metal battery module including the lithium metal battery as a unit cell.

Hereinafter, a lithium metal battery, a method of preparing the lithium metal battery, and a lithium metal battery module including the lithium metal battery as a unit cell will be described in greater detail according to exemplary embodiments.

### Lithium Metal Battery

A lithium metal battery according to an embodiment includes an anode layer including lithium metal or a lithium alloy, a solid electrolyte layer disposed on the anode layer, and a cathode layer disposed on the solid electrolyte layer, and further includes, between the anode layer and the solid electrolyte layer, an interlayer-containing region and an interlayer-free region, wherein the interlayer-containing region includes an interlayer including a carbon-containing material, and at least a portion of the interlayer-free region includes at least one electrolyte selected from a liquid electrolyte, a gel electrolyte, and a polymer electrolyte.

According to an embodiment, the interlayer-free region may be an edge portion between the anode layer and the solid electrolyte layer, a region where the interlayer is absent, other than the edge portion, or a combination thereof.

According to an embodiment, the lithium metal battery may have low charge transfer resistance between the solid electrolyte layer and the anode layer, and may exhibit improved critical current density and areal capacity.

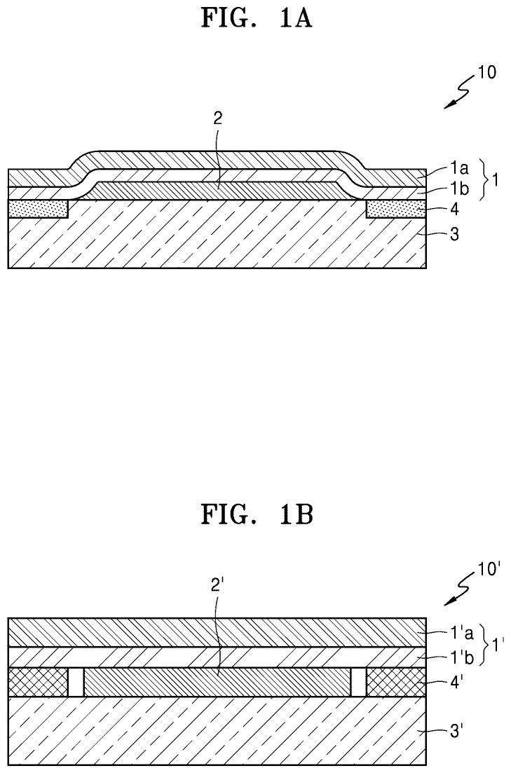

FIG. 1A shows an anode layer/interlayer/solid electrolyte layer structure 10 of a lithium metal battery in an initial or fully discharged state according to an embodiment. FIG. 1B shows an anode layer/interlayer/solid electrolyte layer structure 10′ of a lithium metal battery in an initial or fully discharged state according to another embodiment.

Referring to FIGS. 1A and 1B, the anode layer/interlayer/solid electrolyte layer structure 10, 10′ of the lithium metal battery, in the initial or fully discharged state, may include an anode layer 1, 1′, which is composed of an anode current collector 1a, 1′a and a lithium metal layer or a lithium alloy layer 1b, 1′b, a solid electrolyte layer 3, 3′, and an interlayer-containing region 2, 2′ and an interlayer-free region 4, 4′ positioned between the anode layer and the solid electrolyte layer.

According to an embodiment, the anode current collector 1a, 1′a may be formed of a material that does not react with lithium, meaning that it does not form any alloy or compound with lithium. Examples of suitable materials for the anode current collector 1a, 1a′ may include copper (Cu), stainless steel, titanium (Ti), iron (Fe), cobalt (Co), and nickel (Ni); however, the present disclosure is not limited thereto, and any material employed as an electrode current collector in the art may be used. For example, the anode current collector 1a, 1a′ may have a thickness in a range of about 1 micrometers (μm) to about 50 μm, about 1 μm to about 40 μm, about 1 μm to about 30 μm, about 1 μm to about 20 μm, or about 1 μm to about 10 μm. The anode current collector 1a, 1′a may be composed of a single type of the aforementioned metals, or an alloy or coated material formed of two or more of the aforementioned metals. For example, an anode current collector 1a, 1′a may be in the form of a plate or a foil.

According to an embodiment, the lithium metal layer or lithium alloy layer 1b, 1′b, because it is a metal layer containing lithium, may act as a lithium reservoir. The lithium alloy layer is not limited as long as it contains an element capable of forming an alloy with lithium, but may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like. The lithium metal layer or lithium alloy layer 1b, 1′b may be made of lithium metal alone, one of the aforementioned alloys, or a combination of the aforementioned alloys.

According to an embodiment, the thickness of the lithium metal layer or lithium alloy layer 1b, 1′b is not limited, but may be, for example, in a range of about 1 μm to about 200 μm, about 1 μm to about 150 μm, about 1 μm to about 100 μm, about 1 μm to about 50 μm, about 1 μm to about 40 μm, about 1 μm to about 30 μm, or about 1 μm to about 20 μm. If the thickness of the lithium metal layer or lithium alloy layer 1b, 1′b is excessively small, it may be difficult for the lithium metal layer or the lithium alloy layer 1b, 1′b to serve as a lithium reservoir. If the thickness of the lithium metal layer or lithium alloy layer 1b, 1′b is excessively large, the mass and volume of the lithium metal battery may increase, and the cycle characteristics may rather deteriorate. The lithium metal layer or lithium alloy layer 1b, 1′b may be, for example, a lithium metal foil having a thickness in aforementioned range.

According to an embodiment, the solid electrolyte layer 3, 3′ may be an oxide-containing solid electrolyte, a polymer solid electrolyte, a polymer-inorganic hybrid electrolyte, an organic-inorganic hybrid polymer electrolyte, or a combination thereof.

According to an embodiment, the oxide-containing solid electrolyte may be at least one of Garnet-type ceramics Li₃₊ₓLa₃M₂O₁₂ (M=Te, Nb, or Zr) (where x is an integer from 1 to 10), Li_{1+x+y}AlₓTi₂₋ₓSi_{y}P_{3-y}O₁₂ (0<x<2 and 0≤y<3), lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride-based glass (LiₓN_{y}, 0<x<4, 0<y<2), SiS₂ (LiₓSi_{y}S_{z}, 0<x<3, 0<y<2, 0<z<4), P₂S₅-containing glass (LiₓP_{y}S_{z}, 0<x<3, 0<y<3, and 0<z<7), Li₂O, LiF, LiOH, Li₂CO₃, LiAlO₂, Li₂O—Al₂O₃—SiO₂—P₂O₅—TiO₂—GeO₂ ceramics, and LiBSiO or a combination thereof.

The oxide-containing solid electrolyte may be manufactured by a sintering method, a casting method, or the like.

For example, the oxide-containing solid electrolyte may be a garnet-containing solid electrolyte.

For example, the garnet-containing solid electrolyte may include an oxide represented by Formula 1.

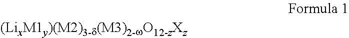

In Formula 1,

6≤x≤8, 0≤y<2, −0.2≤δ≤0.2, −0.2≤ω≤0.2, and 0≤z≤2 may be satisfied,
M1 may be a monovalent cation, a divalent cation, a trivalent cation, or a combination thereof,
M2 may be a monovalent cation, a divalent cation, a trivalent cation, or a combination thereof,
M3 may be a monovalent cation, a divalent cation, a trivalent cation, a tetravalent cation, a pentavalent cation, a hexavalent cation, or a combination thereof, and
X may be a monovalent anion, a divalent anion, a trivalent anion, or a combination thereof.

In Formula 1, examples of the monovalent cation may include Na, K, Rb, Cs, H, Fr, and the like, and examples of the divalent cation may include Mg, Ca, Ba, Sr, and the like. Examples of the trivalent cation may include In, Sc, Cr, Au, B, Al, Ga, and the like, and examples of the tetravalent cation may include Sn, Ti, Mn, Ir, Ru, Pd, Mo, Hf, Ge, V, Si, and the like. Examples of the pentavalent cation may include Nb, Ta, Sb, V, P, and the like.

M1 may be, for example, hydrogen (H), iron (Fe), gallium (Ga), aluminum (Al), boron (B), beryllium (Be), or a combination thereof. M2 may be lanthanum (La), barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof, and M3 may be zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al) or a combination thereof.

In Formula 1, when X is a monovalent anion, the monovalent anion may be a halogen atom, a pseudohalogen, or a combination thereof; when X is a divalent anion, the divalent anion may be S²⁻ or Se²⁻; and when X is a trivalent anion, the trivalent anion may be N³⁻.

In Formula 1, 6.6≤x≤8, 6.7≤x≤7.5, or 6.8≤x≤7.1.

For example, the garnet-containing solid electrolyte may include an oxide represented by Formula 2.

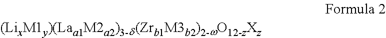

In Formula 2,
M1 may be hydrogen (H), iron (Fe), gallium (Ga), aluminum (Al), boron (B), beryllium (Be), or a combination thereof;
M2 may be barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof;
M3 may be hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al) or a combination thereof;
6≤x≤8, 0≤y<2, −0.25≤δ≤0.2, −0.2≤ω≤0.2, and 0≤z≤2;
a1+a2=1, 0<a1≤1, and 0≤a2<1;
b1+b2=1, 0<b1≤1, and 0≤b2<1; and
X may be a monovalent anion, a divalent anion, a trivalent anion, or a combination thereof.

In Formula 2, when X is a monovalent anion, the monovalent anion may be a halogen atom, a pseudohalogen, or a combination thereof; when X is a divalent anion, the divalent anion may be S²⁻ or Se²⁻; and when X is a trivalent anion, the trivalent anion may be N³⁻.

In Formula 2, 6.6≤x≤8, 6.7≤x≤7.5, or 6.8≤x≤7.1.

As used herein, the term “pseudohalogen” refers to a molecule composed of two or more electronegative atoms that, in the free state, resembles halogens and produces anions similar to halide ions. Examples of the pseudohalogen may include cyanide, cyanate, thiocyanate, azide, or a combination thereof.

The halogen atom may be, for example, iodine (I), chlorine (CI), bromine (Br), fluorine (F), or a combination thereof, and the pseudohalogen is, for example, cyanide, cyanate, thiocyanate, azide, or a combination thereof.

The trivalent anion may be, for example, N³⁻.

In Formula 1, M3 may be, for example, Al, Ga, In, Si, Ge, Sn, Sb, Bi, Sc, Y, Ti, Hf, V, Nb, Ta, W, or a combination thereof.

According to another embodiment, the garnet-containing solid electrolyte may be an oxide represented by Formula 3.

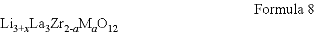

In Formula 3,
M may be Al, Ga, In, Si, Ge, Sn, Sb, Bi, Sc, Y, Ti, Hf, V, Nb, Ta, W, or a combination thereof, and
x may be a number in a range of 1 to 10, and 0≤a<2.

Examples of garnet-containing solid electrolytes may include Li₇La₃Zr₂O₁₂, Li_{6.5}La₃Zr_{1.5}Ta_{0.5}O₁₂, and the like.

The garnet-containing solid electrolyte may exhibit an ionic conductivity of at least 1 milliSiemen per centimeter (mS·cm⁻¹) and may be produced in the form of pellets, tapes, films, and the like. Such a garnet-containing solid electrolyte may be prepared with various thicknesses over a wide temperature range.

Examples of polymer solid electrolytes according to an embodiment may include polyethylene oxide, polypropylene oxide, polystyrene (PS), polyphosphazene, polysiloxane, polyvinylidene fluoride-co-hexafluoropropylene (PVDF-co-HFP), polyacrylonitrile (PAN), or a combination thereof. Such polymer solid electrolytes may achieve ion conductivity through local segmental motion of the polymer. A polymer solid electrolyte may be prepared by mixing a polyether with a plasticizer salt, optionally together with a small amount of a liquid plasticizer. Such electrolytes may be used to produce thin films by a solvent evaporation process. However, the present disclosure is not limited thereto, and any polymer solid electrolyte available in the art may be used. In polymer-inorganic hybrid electrolytes, an inorganic material may act as a filler that disrupts the regularity of the polymer chains; however, because numerous lithium ions can move at high speed along the interface between the polymer and the inorganic filler, the inorganic material may also function as an “active” filler. Examples of such inorganic materials include Al₂O₃, TiO₂, SiO₂, and the like. The aforementioned inorganic materials may be used in polymer-inorganic hybrid electrolytes in various sizes and morphologies.

Examples of organic-inorganic hybrid polymer electrolytes include those based on polyether diamine in combination with alkoxysilane inorganic materials and triazine-containing organic materials. However, the present disclosure is not limited thereto, and any organic-inorganic hybrid polymer electrolyte available in the art may be used. These organic-inorganic hybrid polymer electrolytes may improve high ion conductivity, Coulombic efficiency, initial discharge capacity, and lifespan characteristics.

According to an embodiment, the solid electrolyte layer 3, 3′ may include pores on a surface thereof. The pores on the surface of the solid electrolyte layer 3, 3′ may be formed through surface treatment. Some or all of the pores on the surface of the solid electrolyte layer 3, 3′ may be filled with components of an interlayer-containing region 2, 2′, described below. Examples of such components include carbon-containing materials. When the component of the interlayer-containing region 2, 2′ penetrates some or all of the pores on the surface of the solid electrolyte layer 3, 3′, not only does the contact area between the interlayer-containing region 2, 2′ and the solid electrolyte layer 3, 3′ increase, but a strong adhesion between the layers may also form.

According to an embodiment, the interlayer-containing region 2, 2′ may include a carbon-containing material. The interlayer-containing region 2, 2′ may include at least one carbon-containing material that can be a carbon material, a carbon composite, or a combination thereof, and a binder.

The carbon material may be a porous carbon material or a non-porous carbon material. The carbon material may be in the form of three-dimensional carbon particles. For example, the carbon material may include carbon black particles, graphite particles, carbon nano-flowers, carbon nano-prisms, carbon nano-diamonds, or a combination thereof. These three-dimensional carbon particles may or may not form pores. For example, the three-dimensional carbon material particles may form pores.

The carbon composite may be a composite of a carbon material and a metal material. For example, the metal material may include at least one of iron (Fe), platinum (Pt), cobalt (Co), cadmium (Cd), copper (Cu), titanium (Ti), vanadium (V), chromium (Cr), manganese (Mn), zinc (Zn), nickel (Ni), silver (Ag), gold (Au), palladium (Pd), rubidium (Ru), osmium (Os), molybdenum (Mo), zirconium (Zr), niobium (Nb), lanthanum (La), indium (In), tin (Sn), lead (Pb), or bismuth (Bi). Such carbon composites may exhibit excellent electrical conductivity and a high specific surface area, thereby further improving the charge and discharge characteristics of the lithium metal battery.

The metal material may, for example, be in a particle form. The average particle diameter (D50) of the metal material may be about 4 μm or less, about 3 μm or less, about 2 μm or less, about 1 μm or less, or about 0.5 μm or less. The lower limit of the average particle diameter (D50) is not particularly limited but may be about 10 nanometers (nm) or more. The average particle diameter (D50) is defined, in the cumulative distribution curve where particles are arranged in ascending order of particle size, as the diameter corresponding to 50% of the total number of particles when the total number of particles is set to 100%. The average particle diameter (D50) may be measured by any method well known to those skilled in the art, for example, by using a particle size analyzer or from transmission electron microscopy (TEM) or scanning electron microscope (SEM) images. Alternatively, it may be measured using equipment that employs dynamic light scattering, from which data analysis and particle count across each size range allow the average particle diameter (D50) to be readily obtained by calculation.

In the carbon composite, the mixing weight ratio of the carbon material to the metal material may be, for example, in a range of about 10:1 to about 1:10, about 5:1 to about 1:5, about 4:1 to about 1:4, about 3:1 to about 1:3, or about 2:1 to about 1:2, but is not necessarily limited thereto and may be selected according to the required characteristics of the lithium metal battery.

The aforementioned carbon-containing material may provide a pathway for lithium atom transport from the solid electrolyte layer 3,3′ to the anode layer 1,1′. When the carbon-containing material has pores, such pores may be partially or entirely filled with lithium, enabling the material to rapidly supply or remove lithium from the solid electrolyte layer 3,3′ to the anode layer 1,1′ by diffusion. Consequently, the lithium metal battery may achieve an improved discharge capacity. In addition, even when a reduced amount of binder is used, the lithium metal battery may reinforce the mechanical structure between the solid electrolyte layer 3,3′ and the anode layer 1,1′, thereby enhancing the overall battery performance.

According to an embodiment, the interlayer-containing region 2, 2′ may further include a binder. The binder may be an aqueous binder, an organic binder, or a combination thereof.

The aqueous binder may exhibit low reactivity and serve to enhance adhesion with the solid electrolyte layer 3, 3′. In addition, the aqueous binder may reduce the required binder content due to its superior adhesion to the solid electrolyte layer 3, 3′, and may be environmentally friendly by using water as the solvent.

For example, the aqueous binder may include at least one polymer, for example polyvinyl alcohol, polyacrylic acid, polymethacrylic acid, polyvinyl alcohol-grafted polyacrylic acid, polyvinyl alcohol-grafted polymethacrylic acid, carboxymethyl cellulose, or copolymers thereof. Among the aforementioned examples, at least one of polyvinyl alcohol-grafted polyacrylic acid and polyvinyl alcohol-grafted polymethacrylic acid, or a copolymer thereof, may be used as the aqueous binder. Such grafted polymer or copolymer binders may not only exhibit enhanced adhesion compared to linear polymers or copolymers, but also possess superior elasticity. Accordingly, a lithium metal battery, in which the interlayer-containing region 2, 2′ includes a grafted polymer or copolymer as a binder, may achieve further improved charge and discharge characteristics.

The content of the aqueous binder may be in a range of about 0.1 weight percent (wt %) to about 7 wt % based on 100 wt % of the entire interlayer-containing region 2, 2′. Even if such a small amount of binder is used, the adhesion between the solid electrolyte layer 3, 3′ and the anode layer 1, 1′ may be improved, and a robust mechanical structure may be thus obtained, leading to enhanced battery performance.

For example, the organic binder may include one or more polymers such as of butadiene rubber, nitrile-butadiene rubber, hydrogenated nitrile-butadiene rubber, styrene-butadiene rubber, styrene-butadiene-styrene rubber, acrylate-butadiene rubber, acrylonitrile-butadiene-styrene rubber, polyvinylidene fluoride, a copolymer of vinylidene fluoride and hexafluoropropylene, polyisobutylene, polyethylene, polypropylene, polyimide, or copolymers thereof.

Optionally, the interlayer-containing region 2, 2′ may further include an electrically conductive polymer.

Examples of the electrically conductive polymer may include poly(fluorene), polyphenylene, polypyrene, polyazulene, polynaphthalene, polyacetylene (PAC), poly(p-phenylenevinylene) (PPV), polypyrrole (PPY), polycarbazole, polyindole, polyazepine, polyaniline (PANI), polythiophene (PT), poly(3,4-ethylenedioxythiophene) (PEDOT), poly(p-phenylene sulfide) (PPS), and the like. When the interlayer-containing region 2, 2′ further includes the electrically conductive polymer, the charge and discharge characteristics of the battery may be further improved.

The interlayer-containing region 2, 2′ may have a thickness in a range of about 1 μm to about 30 μm. For example, the interlayer-containing region (2, 2′) may have a thickness of about 1 μm to about 28 μm, about 1 μm to about 26 μm, about 1 μm to about 24 μm, about 1 μm to about 22 μm, about 1 μm to about 20 μm, about 1 μm to about 18 μm, about 1 μm to about 16 μm, about 1 μm to about 14 μm, about 1 μm to about 12 μm, about or 1 μm to about 12 μm. Within the aforementioned thickness range, the interlayer-containing region 2, 2′ may prevent a decrease in energy density.

According to an embodiment, the length of the interlayer-containing region 2, 2′ in a horizontal direction may be smaller than the length of the anode layer 1, 1′ and the solid electrolyte layer 3, 3′ in a horizontal direction.

According to an embodiment, the area of the interlayer-containing region 2, 2′ may be smaller than the area of the anode layer 1, 1′.

For example, the area of the interlayer-containing region 2, 2′ may be in a range of about 30% to about 80% based on 100% of the total surface area of the solid electrolyte layer 3, 3′. For example, the area of the interlayer-containing region 2, 2′ may be in a range of about 40% to about 80%, or about 50% to about 80%, based on 100% of the total surface area of the solid electrolyte layer 3, 3′.

The interlayer-free region may be present at the edge portion on one side, or both sides of the interlayer.

According to an embodiment, the interlayer-free region 4, 4′, such as interface edges between the anode layer 1, 1′ and the solid electrolyte layer 3, 3′, a region where the interlayer is absent, other than the edge portion, or a combination thereof, may include at least one of a liquid electrolyte, a gel electrolyte, or a polymer electrolyte.

In an embodiment, the liquid electrolyte and the gel electrolyte may include an ionic liquid compound and a lithium salt.

The ionic liquid compound may an ionic liquid compound including: i) at least one cation, for example an ammonium-type, pyrrolidinium-type, pyridinium-type, pyrimidinium-type, imidazolium-type, piperidinium-type, pyrazolium-type, oxazolium-type, pyridazinium-type, phosphonium-type, sulfonium-type, triazolium-type, or a combination thereof; and ii) at least one anion, for example BF₄—, PF₆—, AsF₆—, SbF₆—, AlCl₄—, HSO₄—, ClO₄—, CH₃SO₃—, CF₃CO₂—, (CF₃SO₂)₂N—, Cl—, Br—, I—, BF₄—, SO₄—, PF₆—, ClO₄—, CF₃SO₃—, CF₃CO₂—, (C₂F₅SO₂)₂N—, (C₂F₅SO₂)(CF₃SO₂)N—, NO₃—, Al₂Cl₇—, AsF₆—, SbF₆—, CF₃COO—, CH₃COO—, CF₃SO₃—, (CF₃SO₂)₃C—, (CF₃CF₂SO₂)₂N—, (CF₃)₂PF₄—, (CF₃)₃PF₃—, (CF₃)₄PF₂—, (CF₃)₅PF—, (CF₃)₆P—, SF₅CF₂SO₃—, SF₅CHFCF₂SO₃—, CF₃CF₂(CF₃)₂CO—, (CF₃SO₂)₂CH—, (SF₅)₃C—, (O(CF₃)₂C₂(CF₃)₂O)₂PO—, or (CF₃SO₂)₂N—.

For example, the ionic liquid compound may be at least one of N-methyl-N-propyl-pyrrolidinium bis(trifluoromethanesulfonyl)imide, N-methyl-N-propyl-pyrrolidinium(fluorosulfonyl)imide, N-butyl-N-methyl-pyrrolidinium bis(3-trifluoromethanesulfonyl)imide, N-butyl-N-methyl-pyrrolidinium bis(3-fluorosulfonyl)imide, 1-butyl-3-methylimidazolium bis(trifluoromethanesulfonyl)imide, or 1-ethyl-3-methylimidazolium bis(trifluoromethanesulfonyl)imide.

For example, the ionic liquid compound may be [emim]Cl/AlCl₃(emim=ethyl methyl imidazolium), [bmpyr]NTf2(bppyr=butyl methyl pyridinium), [bpy]Br/AlCl₃(bpy=4, 4′-bipyridine), [choline]Cl/CrCl₃·6H₂O, [Hpy(CH₂)₃pyH][NTf₂]₂ (py=pyridinium, NTf=trifluoromethanesulfonimide), [emim]OTf/[hmim]I(hmim=hexyl methyl imidazolium), [choline]Cl/HOCH₂CH₂OH, [Et₂MeN(CH₂CH₂OMe)]BF₄ (Et=ethyl, Me=methyl, Pr=propyl, Bu=butyl, Ph=phenyl, Oct=octyl, Hex=hexyl), [Bu₃PCH₂CH₂C₈F₁₇]OTf(OTf=trifluoromethane sulfonate), [bmim]PF₆(bmim=butyl methyl imidazolium), [bmim]BF₄, [omim]PF₆(omim=octyl methyl imidazolium), [Oct₃PC₁₈H₃₇]I, [NC(CH₂)₃mim]NTf₂(mim=methyl imidazolium), [Pr₄N][B(CN)₄], [bmim]NTf₂, [bmim]Cl, [bmim][Me(OCH₂CH₂)₂OSO₃], [PhCH₂mim]OTf, [Me₃NCH(Me)CH(OH)Ph]NTf₂, [pmim][(HO)₂PO₂](pmim=propyl methyl imidazolium), [b(6-Me)quin]NTf₂(bquin=butyl quinolinium, [bmim][Cu₂Cl₃], [C₁₈H₃₇OCH₂mim]BF₄(mim=methyl imidazolium), [heim]PF₆(heim=hexyl ethyl imidazolium), [mim(CH₂CH₂O)₂CH₂CH₂mim][NTf₂]₂(mim=methyl imidazolium), [obim]PF₆(obim=octyl butyl imidazolium), [oquin]NTf₂(oquin=octyl quinolinium), [hmim][PF₃(C₂F₅)₃], [C₁₄H₂₉mim]Br(mim=methyl imidazolium), [Me₂N(C₁₂H₂₅)₂]NO₃, [emim]BF₄, [mm(3-NO₂)im][dinitrotriazolate](mm(3-NO₂)im=dimethyl-3-NO2-imidazolium), [MeN(CH₂CH₂OH)₃], [MeOSO₃], [Hex₃PC₁₄H₂₉]NTf₂, [emim][EtOSO₃], [choline][ibuprofenate], [emim]NTf₂, [emim][(EtO)₂PO₂], [emim]Cl/CrCl₂, [Hex₃PC₁₄H₂₉]N(CN)₂, or the like.

For example, the ionic liquid compound may have a molecular weight in a range of about 50 Dalton to about 1,500 Dalton, about 50 Dalton to about 1,000 Dalton, about 50 Dalton to about 900 Dalton, about 50 Dalton to about 800 Dalton, or about 50 Dalton to about 700 Dalton or less. By having a molecular weight in aforementioned range, the ionic conductivity of the liquid electrolyte or gel electrolyte may further improve.

The lithium salt may have a concentration of about 0.1 M to about 5 M, and may include one or more of LiPF₆, LiBF₄, LiCF₃SO₃, Li(CF₃SO₂)₂N, Li(CF₃SO₂)₃C, LiC₂F₅SO₃, Li(FSO₂)₂N, LiC₄F₉SO₃, LiN(SO₂CF₂CF₃)₂, LiN(CN)₂, or a compound represented by Formulas 11 to 14

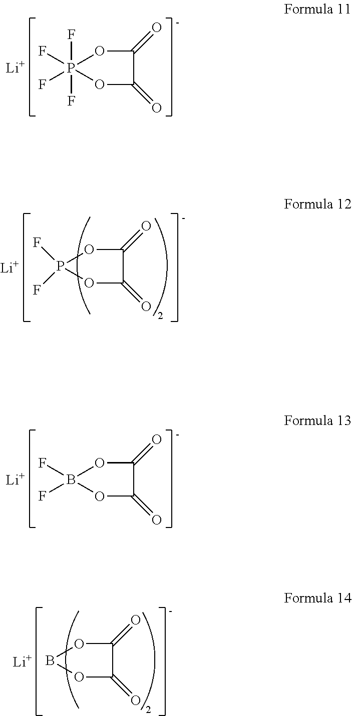

According to an embodiment, the polymer electrolyte may include a polymer or copolymer including an ion-conductive repeating unit, and a lithium salt. The ion-conductive repeating unit may be a unit capable of ion conductivity, and may be, for example, an alkylene oxide unit, a hydrophilic unit, or the like.

For example, the ion-conductive repeating unit may include an ether-containing monomer, an acrylic monomer, a methacrylic monomer, a siloxane-containing monomer, or a combination thereof. For example, the polymer including the ion-conductive repeating unit may be polyethylene oxide, polypropylene oxide, polymethyl methacrylate, polyethyl methacrylate, polydimethylsiloxane, polyacrylic acid, polymethacrylic acid, polymethyl acrylate, polyethyl acrylate, polyethylhexyl acrylate, polybutyl methacrylate, poly 2-ethylhexyl methacrylate, polydecyl acrylate, polyethylene vinyl acetate, or a combination thereof. The ion-conductive polymer may be, for example, polyethylene oxide (PEO), polyvinyl alcohol (PVA), polyvinylpyrrolidone (PVP), polysulfone, or a combination thereof.

Alternatively, the polymer electrolyte may include an ionic liquid polymer. Such an ionic liquid polymer may have a repeating unit containing: (i) one or more cations of ammonium-type, pyrrolidinium-type, pyridinium-type, pyrimidinium-type, imidazolium-type, piperidinium-type, pyrazolium-type, oxazolium-type, pyridazinium-type, phosphonium-type, sulfonium-type, triazolium-type, or a combination thereof; and (ii) one or more anions of BF₄—, PF₆—, ASF₆—, SbF₆—, AlCl₄—, HSO₄—, ClO₄—, CH₃SO₃—, CF₃CO₂—, (CF₃SO₂)₂N—, Cl—, Br—, I—, BF₄—, SO₄—, PF₆—, ClO₄—, CF₃SO₃—, CF₃CO₂—, (C₂F₅SO₂)₂N—, (C₂F₅SO₂)(CF₃SO₂)N—, NO₃—, Al₂Cl₇—, AsF₆—, SbF₆—, CF₃COO—, CH₃COO—, CF₃SO₃—, (CF₃SO₂)₃C—, (CF₃CF₂SO₂)₂N—, (CF₃)₂PF₄—, (CF₃)₃PF₃—, (CF₃)₄PF₂—, (CF₃)₅PF—, (CF₃)₆P—, SF₅CF₂SO₃—, SF₅CHFCF₂SO₃—, CF₃CF₂(CF₃)₂CO—, (CF₃SO₂)₂CH—, (SF₅)₃C—, (O(CF₃)₂C₂(CF₃)₂O)₂PO—, or (CF₃SO₂)₂N—. The ionic liquid polymer may be, for example, poly(diallyldimethylammonium trifluoromethanesulfonylimide) (poly(diallyldimethylammonium)TFSI), poly(1-allyl-3-methylimidazolium trifluoromethanesulfonylimide), poly(N-methyl-N-propylpiperidinium bis(trifluoromethanesulfonylimide) (poly((N-Methyl-N-propylpiperidinium bis(trifluoromethanesulfonyl)imide))), or a combination thereof.

According to an embodiment, the lithium metal battery may include lithium cations in a region that does not include the interlayer 4, 4′.

Thus, in the lithium metal battery, an electrolyte may be located in the region that does not include the interlayer 4, 4′ and come into direct contact with lithium. Hence, the lithium metal battery may exhibit a low charge transfer resistance between the solid electrolyte layer 3, 3′ and the anode layer 1, 1′, and may achieve an improved critical current density and areal capacity.

According to an embodiment, during charging or discharging of the lithium metal battery, a lithium layer may be formed at some or all of the interface between the interlayer-containing region of the interlayer 2, 2′ and the solid electrolyte layer 3, 3′.

According to an embodiment, a cathode layer may include a cathode current collector and a cathode active material layer.

The cathode current collector may use a metal substrate. Examples of the metal substrate may be aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The cathode current collector may be in the form of a plate or foil. The cathode current collector may be omitted.

The cathode active material may be any material commonly used in lithium metal batteries, without limitation. For example, the cathode active material may be one or more of composite oxides of lithium with a metal of cobalt, manganese, nickel, and a combination thereof, and specific examples thereof include LiₐA_{1-b}B′_{b}D′₂ (wherein 0.90≤a≤1.8 and 0≤b≤0.5); LiₐE_{1-b}B′_{b}O_{2-c}D′_{c} (wherein 0.90≤a≤1.8, 0≤b≤0.5, 0≤c≤0.05); LiE_{2-b}B′_{b}O_{4-c}D′_{c} (wherein 0≤b≤0.5, 0≤c≤0.05); LiₐNi_{1-b-c}Co_{b}B′_{c}D′ₐ (wherein 0.90≤a≤1.8, 0≤b≤0.5, 0≤c≤0.05, 0<α≤2); LiₐNi_{1-b-c}Co_{b}B′_{c}O_{2-α}F′_{α} (wherein 0.90≤a≤1.8, 0≤b≤0.5, 0≤c≤0.05, 0<α<2); LiₐNi_{1-b-c}Co_{b}B′_{c}O_{2-α}F′₂ (wherein 0.90≤a≤1.8, 0≤b≤0.5, 0≤c≤0.05, 0<α<2); LiₐNi_{1-b-c}Mn_{b}B′_{c}D′_{α} (wherein 0.90≤a≤1.8, 0≤b≤0.5, 0≤c≤0.05, 0<α≤2); LiₐNi_{1-b-c}Mn_{b}B′_{c}O_{2-α}F′_{α} (wherein 0.90≤a≤1.8, 0≤b≤0.5, 0≤c≤0.05, 0<α<2); LiₐNi_{1-b-c}Mn_{b}B′_{c}O_{2-α}F′₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001<d≤0.1.); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1.); LiₐNiG_{b}O₂ (wherein 0.90≤a≤1.8, 0.001≤b≤0.1.); LiₐCoG_{b}O₂ (wherein 0.90≤a≤1.8, 0.001<b≤0.1.); LiₐMnG_{b}O₂ (wherein 0.90≤a≤1.8, 0.001≤b≤0.1.); LiₐMn₂G_{b}O₄ (wherein 0.90≤a≤1.8, 0.001≤b≤0.1.); QO₂; QS₂; LiQS₂; V₂O₅; LiV₂O₂; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄.

In the above formulas, A may be Ni, Co, Mn, or a combination thereof; B′ may be Al, Ni, Co, Mn, Cr, Fe, Mg, Sr, V, a rare earth element, or a combination thereof; D′ may be 0, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, the cathode active material may include one or more of lithium cobalt oxide, lithium nickel oxide, lithium nickel cobalt oxide, lithium nickel cobalt aluminum oxide, lithium nickel cobalt manganese oxide, lithium manganese oxide, lithium iron phosphate oxide, nickel sulfide, copper sulfide, lithium sulfide, iron oxide, or vanadium oxide. For example, the cathode active material may be LiCoO₂, LiMnₓO₂ (x=1, 2), LiNi₁₋ₓMnₓO₂ₓ (0<x<1), LiNi_{1-x-y}CoₓMn_{y}O₂ (0≤x≤0.5, 0≤y≤0.5), LiFePO₄, TiS₂, FeS₂, TiS₃, or FeS₃.

The cathode active material layer may further include a cathode electrolyte. The cathode electrolyte may include an ionic liquid compound and a lithium salt. The ionic liquid compound may be non-volatile. The ionic liquid compound refers to a room-temperature molten salt that consists solely of ions and has a melting point below room temperature.

The ionic liquid compound may be selected from a compound containing: a) one or more cations such as an ammonium-type, pyrrolidinium-type, pyridinium-type, pyrimidinium-type, imidazolium-type, piperidinium-type, pyrazolium-type, oxazolium-type, pyridazinium-type, phosphonium-type, sulfonium-type, triazolium-type, or a combination thereof; and b) one or more anions such as BF₄—, PF₆—, AsF₆—, SbF₆—, AlCl₄—, HSO₄—, ClO₄—CH₃SO₃—, CF₃CO₂—, Cl—, Br, I—, SO₄—, CF₃SO₃—, (FSO₂)₂N—, (C₂F₅SO₂)₂N—, (C₂F₅SO₂)(CF₃SO₂)N—, or (CF₃SO₂)₂N—. For example, the ionic liquid electrolyte may be at least one of N-methyl-N-propylpyrrolidinium bis(trifluoromethanesulfonyl)imide, N-butyl-N-methylpyrrolidinium bis(trifluoromethanesulfonyl)imide, 1-butyl-3-methylimidazolium bis(trifluoromethylsulfonyl)imide, 1-ethyl-3-methylimidazolium bis(trifluoromethylsulfonyl)imide, or 1-ethyl-3-methylimidazolium bis(fluorosulfonyl)imide.

The ionic liquid compound may have a viscosity in a range of about 50 centipoises (cps) to about 500 cps. For example, the viscosity may be in a range of about 50 cps to about 450 cps, about 70 cps to about 400 cps, or about 100 cps to about 300 cps. Within the aforementioned viscosity range, the lithium metal battery may secure electrochemical stability during charging and discharging.

The ionic liquid compound may be filled in some or all of the pores on the surface of the solid electrolyte layer in contact with the cathode active material layer. The content of the ionic liquid compound may be in a range of about 0.1 parts by weight to about 20 parts by weight, about 0.1 parts by weight to about 15 parts by weight, about 0.1 parts by weight to about 10 parts by weight, or about 0.1 parts by weight to about 5 parts by weight, with respect to 100 parts by weight of the cathode active material layer not including the ionic liquid compound. By including the ionic liquid compound, the ionic conductivity may be further improved, and the charge-discharge characteristics of the lithium metal battery may be further improved.

The cathode active material layer may further include a conductive material and a binder.

For example, the conductive material may include carbon black, carbon fiber, graphite, or a combination thereof. For example, the carbon black may be acetylene black, Ketjen black, Super P carbon, channel black, furnace black, lamp black, thermal black, or a combination thereof. The graphite may be natural graphite or artificial graphite. For the conductive material, a combination of one or more materials selected from the aforementioned examples may be used.

The cathode active material layer may further include, in addition to the aforementioned conductive material, another conductive material having a different composition. Such additional conductive materials may include electrically conductive fibers (e.g., metal fibers); carbon fluoride powder; metal powders such as aluminum powder or nickel powder; conductive whiskers such as zinc oxide or potassium titanate; polyethylene derivatives; or a combination thereof. The content of the conductive material may be in a range of about 1 part by weight to about 10 parts by weight, for example, about 2 parts by weight to about 7 parts by weight, based on 100 parts by weight of the cathode active material. When the conductive material is present in such an amount (e.g., about 1 part by weight to about 10 parts by weight), the electrical conductivity of the cathode layer may be appropriately maintained.

The binder may improve the adhesion between the components of the cathode layer as well as the adhesion to the cathode current collector. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene monomer (EPDM), sulfonated EPDM, styrene-butadiene rubber, fluorinated rubber, copolymers thereof, or a combination thereof. The content of the binder may be in a range of about 1 part by weight to about 10 parts by weight, for example, in a range of about 2 parts by weight to about 7 parts by weight, based on 100 parts by weight of the cathode active material. When the content of the binder is within the aforementioned range, the adhesion of the cathode active material layer to the cathode current collector may be further improved, and a decrease in energy density of the cathode active material layer may be suppressed.

As the solvent, N-methylpyrrolidone, acetone, water, or the like may be used. The contents of the cathode active material, the conductive material, the binder, and the solvent are at levels commonly used in lithium batteries.

By further adding a plasticizer to the cathode active material layer, it may be possible to create pores inside the cathode active material layer.

According to an embodiment, the lithium metal battery may have a charge-transfer resistance (R_{ct}) in a range of about 240 ohms (ω) to about 200Ω as measured by electrochemical impedance spectroscopy (EIS) at 25° C. For example, at 25° C., the charge-transfer resistance (R_{ct}) measured by electrochemical impedance spectroscopy (EIS) may be about 220Ω to about 180Ω, or about 200Ω to about 160Ω.

According to an embodiment, the lithium metal battery may have a high discharge capacity and a high energy density. The shape of the lithium metal battery is not particularly limited and may be, for example, a coin type, button type, sheet type, stacked type, cylindrical type, or flat type. Further, the lithium metal battery may also be applied to large-sized batteries used in electric vehicles and the like. For example, the lithium metal battery may also be used in hybrid vehicles such as plug-in hybrid electric vehicles (PHEVs). The lithium metal battery may also be employed in fields requiring large-capacity power storage, such as electric bicycles or electric power tools, among others.

### Method of Preparing Lithium Metal Battery

According to an embodiment, a method of preparing a lithium metal battery may include: combining, e.g., mixing at least one carbon-containing material, e.g., a carbon material, a carbon composite, or a combination thereof; and a binder, to prepare an interlayer-forming composition; applying and drying the interlayer-forming composition on a first surface of a solid electrolyte, at a coverage of about 30% to about 99.9% based on a total surface area of the first surface, thereby preparing a solid electrolyte layer having the interlayer formed thereon; contacting at least one of a liquid electrolyte, a gel electrolyte, or a polymer electrolyte with a surface of the solid electrolyte layer on which the interlayer is not formed; placing an anode layer on the first surface of the solid electrolyte layer having the interlayer formed thereon and on the surface of the solid electrolyte layer in contact with the at least one of the liquid electrolyte, the gel electrolyte, or the polymer electrolyte; and placing a cathode layer on the second surface of the solid electrolyte layer having the anode layer placed thereon, to prepare the lithium metal battery.

According to an embodiment, the method of preparing a lithium metal battery may provide a structurally robust lithium metal battery with low charge-transfer resistance between the solid electrolyte layer and the anode layer, and with improved critical current density and areal capacity, without using cold isostatic pressing (CIP) and/or warm isostatic pressing (WIP).

First, an interlayer-forming composition may be prepared by mixing at least one carbon-containing material, e.g., a carbon material, a carbon composite, or a combination thereof, with a binder. The interlayer-forming composition may include at least one carbon-containing material, e.g., a carbon material, a carbon composite, a combination thereof, a binder, and a solvent. The binder may be an aqueous binder, an organic binder, or a combination thereof. The content of the binder may be in a range of about 0.1 parts by weight to about 10 parts by weight, about 0.1 parts by weight to about 7 parts by weight, or about 0.1 parts by weight to about 5 parts by weight, based on 100 parts by weight of the interlayer-forming composition.

The solvent may be water, deionized water, or an organic solvent. Examples of the organic solvent may include alcohol-containing solvents such as ethanol, propanol, butanol, 1,5-pentanediol, and 1-methylamino-2,3-propanediol; lactone-containing solvents such as ε-caprolactone and α-acetyl γ-butyrolactone; glycol-containing solvents such as diethylene glycol, 1,3-butylene glycol, and propylene glycol; glycol ether-containing solvents such as triethylene glycol dimethyl ether, tripropylene glycol dimethyl ether, and diethylene glycol monobutyl ether; carbonate-containing solvents such as propylene carbonate and ethylene carbonate; N-methylpyrrolidone (NMP) solvent; dimethylformamide (DMF) solvent; acetone solvent; and dimethylacetamide solvent. The aforementioned solvents may be used alone or in combination of two or more thereof.

Next (or before formation of the interlayer-forming composition), a solid electrolyte molded body may be prepared. For example, the solid electrolyte molded body may be prepared by heat-treating a precursor of a solid electrolyte material, specifically, an oxide-containing solid electrolyte material.

The oxide-containing solid electrolyte may be prepared by contacting precursors in stoichiometric amounts to form a mixture, followed by heat treatment of the mixture.

The contacting may include milling or pulverization, for example, ball milling. The mixture of precursors mixed in a stoichiometric composition may be subjected to a first heat treatment in an oxidizing atmosphere to prepare a first heat treatment product.

The first heat treatment may be performed at a temperature of 1,000° C. or less, for a duration of about 1 hour to 36 hours. The first heat-treated product may be pulverized.

The pulverization of the first heat-treated product may be done, either in a dry process or a wet process.

In the wet process, for example, the first heat-treated product may be mixed with a solvent such as methanol, followed by ball milling for about 0.5 hours to about 10 hours.

In the dry process, milling may be carried out by a ball mill or the like, without using a solvent. The particle size of the first heat-treated product, after pulverization, may be in a range of about 0.1 μm to about 10 μm, or about 0.1 μm to about 5 μm. The pulverized first heat-treated product may be dried.

The pulverized first heat-treated product may be mixed with a binder solution and molded into a pellet form, or may be simply pressed at a pressure of about 1 ton to about 10 tons to be molded into a pellet. The molded body may be subjected to a second heat treatment at a temperature of less than 1,000° C. for a duration of about 1 hour to about 36 hours. A solid electrolyte molded body 11, which is a sintered product, may be obtained through this second heat treatment. The second heat treatment may be conducted, for example, at a temperature of about 550° C. to about 1,000° C. The duration of the first heat treatment may be about 1 hour to about 36 hours. To obtain a sintered product, the temperature of the second heat treatment is higher than the temperature of the first heat treatment. For example, the temperature of the second heat treatment may be 10° C. or higher, 20° C. or higher, 30° C. or higher, or 50° C. or higher than the temperature of the first heat treatment. The molded product may be subjected to the second heat treatment in an oxidizing atmosphere, a reducing atmosphere, or both. The second heat treatment may be performed in a) an oxidizing atmosphere, b) a reducing atmosphere, or c) an oxidizing atmosphere and a reducing atmosphere.

Alternatively, the oxide-containing solid electrolyte may be produced using a tape-casting method. For example, an oxide-containing solid electrolyte slurry may be prepared by mixing oxide solid electrolyte powder with a binder and a solvent. The oxide-containing solid electrolyte slurry may be ball-milled for about 12 hours to about 24 hours, and then aged for about 1 hour to about 4 hours. The aged oxide-containing solid electrolyte slurry may be poured onto a doctor blade set to a predetermined height, and a PET substrate film may be moved at a speed of about 1.0 meter per minute (m/m in) to about 3.0 m/min to perform tape casting, thereby obtaining a green sheet having a thickness of several tens of micrometers. The green sheet may be subjected to lamination, pressing, and cutting processes, and then sintered at a temperature of 1,000° C. to 1,350° C. to obtain a sintered body. By placing the sintered body into a mold and applying pressure, a molded solid electrolyte body having a thickness of several hundred micrometers may be prepared.

Next, prior to applying and drying the interlayer-forming composition on the first surface of the solid electrolyte, a surface treatment may be performed on the first surface of the solid electrolyte. Specifically, the molded solid electrolyte body may be subjected to surface treatment to form a solid electrolyte layer that includes pores on its surface. The surface treatment may include, for example, chemical treatment, electrolytic polishing, wet polishing, argon plasma etching, oxygen plasma cleaning, annealing, or exposure to high vacuum, or a combination thereof.

According to an embodiment, the surface treatment may involve performing an acid treatment one or more times. For example, the acid treatment may use hydrochloric acid, phosphoric acid, sulfuric acid, nitric acid, hydrofluoric acid, or a mixed acid thereof. For example, the acid treatment may be performed at a concentration of about 0.1 M to about 10 M, for a duration of about 10 seconds to about 20 minutes. For example, the acid treatment may be performed with hydrochloric acid at a concentration of about 0.1 M to about 2 M at a temperature of about 25° C. to about 50° C. in air, for a duration of about 1 minute to about 10 minutes. Additionally, in air at a temperature of about 25° C. to about 50° C., the acid treatment may be conducted with phosphoric acid at a concentration of 0.1 M to 1 M for a duration of about 10 seconds to about 30 seconds. After the acid treatment, the surface-treated solid electrolyte may be washed, e.g., with alcohol and then dried, e.g., in a dry room to obtain a solid electrolyte layer including pores on its surface.

Next, the interlayer-forming composition may be coated and dried on the first surface of the surface-treated solid electrolyte at a coverage of about 30% to about 99.9% based on the total surface area of the first surface, thereby preparing a solid electrolyte layer having the interlayer formed thereon. In other words, the interlayer may have a horizontal length that is shorter than the horizontal length of either the anode layer or the solid electrolyte layer. Non-limiting examples of the coating method include doctor blade coating, bar coating, screen printing, spray coating, and the like. The drying may be carried out at room temperature for about 10 minutes to about 1 hour.

The thickness of the interlayer may be, for example, in a range of about 1 μm to about 30 μm. For example, the interlayer may have a thickness in a range of about 1 μm to about 28 μm, about 1 μm to about 26 μm, about 1 μm to about 24 μm, about 1 μm to about 22 μm, about 1 μm to about 20 μm, about 1 μm to about 18 μm, about 1 μm to about 16 μm, about 1 μm to about 14 μm, about 1 μm to about 12 μm, or about 1 μm to about 10 μm. Within the aforementioned thickness range, the interlayer may prevent a decrease in energy density.

Next, at least one of a liquid electrolyte, a gel electrolyte, or a polymer electrolyte may be brought into contact with a surface of the solid electrolyte layer where the interlayer is not formed. Examples of such contact may include dropping, coating, impregnating, and the like.

Natural pre-lithiation may occur at the edge portion between the anode layer and the solid electrolyte layer, a region where the interlayer is absent, other than the edge portion, or both regions thereof.

When there is direct electrical contact between the anode current collector and the lithium metal layer or lithium alloy layer—i.e., under conditions in which, during charging or discharging of the lithium metal battery, a potential difference arises between the lithium metal layer or lithium alloy layer and the interlayer—a lithium plating layer corresponding to a reduction potential may form at some or all of the interface between the interlayer and the solid electrolyte layer. In other words, the lithium metal battery may undergo natural pre-lithiation.

Next, an anode layer may be placed on the first surface of the solid electrolyte layer on which the interlayer is formed. The anode layer may include the anode current collector and either a lithium metal layer or a lithium alloy layer, as described above.

Next, a cathode layer may be placed on the second surface of the solid electrolyte layer having the anode layer placed thereon, thereby providing the lithium metal battery. The cathode layer may include a cathode current collector and a cathode active material layer. The cathode active material layer may include the aforementioned cathode active material and a catholyte. The catholyte may include an ionic liquid compound and a lithium salt. The catholyte may be infiltrated into surface pores of the solid electrolyte layer that are in contact with the cathode active material layer, as well as into the interior of the cathode layer.

Under vacuum, the naturally pre-lithiated anode layer/interlayer/solid electrolyte layer structure and the cathode layer may be placed inside an aluminum pouch, for example, and sealed. At this stage, portions of the cathode current collector and the anode current collector may be made to protrude outside the aluminum pouch without breaking the vacuum of the battery, thus serving as the cathode and anode terminals, respectively.

### Lithium Metal Battery Module Including Lithium Metal Battery as Unit Cell

According to another embodiment, a lithium metal battery module including a lithium metal battery as a unit cell may include: an anode layer containing lithium metal or a lithium alloy; a solid electrolyte layer disposed on the anode layer; and a cathode layer disposed on the solid electrolyte layer, and may further include, between the anode layer and the solid electrolyte layer, an interlayer-containing region and an interlayer-free region, wherein the interlayer-containing region may include an interlayer including a carbon-containing material, and at least a portion of the interlayer-free region may include at least one electrolyte of a liquid electrolyte, a gel electrolyte, or a polymer electrolyte.

According to an embodiment, the lithium metal battery module may include: a battery stack in which a plurality of lithium metal battery unit cells are stacked; and a support member disposed on one or both sides of the battery stack. The battery stack may be stacked in a thickness direction of the lithium metal battery. The pressure applied to the battery stack by the support member may be 1 megapascals (MPa) or less. Alternatively, the support member may not apply any pressure to the battery stack. The support member may be a plate, a case, or a frame for fixing a plurality of lithium metal battery unit cells, without being limited thereto; any support member commonly employed in the art may be used.

Optionally, an elastic material may be further included between the battery stack and the support member. Optionally, an elastic material may be further included between the plurality of lithium metal battery unit cells.

For example, the elastic material may include a urethane-containing polymer, an acrylate-containing polymer, a silicone-containing polymer, a fluorine-containing polymer, copolymers thereof, or a combination thereof.

For example, the elastic material may include an elastic sheet.

For example, the compressive strain of the elastic sheet may be about 30% to about 70%, or about 35% to about 60%. An elastic sheet satisfying a compressive strain within the aforementioned range may effectively relieve stress and reduce internal pressure changes between the lithium metal battery module or the plurality of lithium metal battery unit cells, thereby adequately absorbing shocks.

For example, the elastic sheet may have a thickness of about 50 μm to about 400 μm.

For example, the elastic sheet may have a thickness of about 100 μm to about 300 μm.

The elastic sheet having a thickness in the aforementioned range can relieve stress and withstand internal pressure between the lithium metal battery module or the plurality of lithium metal battery unit cells.

According to another embodiment, a battery pack may include a lithium metal battery module, which incorporates the aforementioned lithium metal battery as a unit cell. Such a battery pack may be used in electric vehicles, hybrid electric vehicles (HEVs), plug-in hybrid electric vehicles (PHEVs), and the like.

Hereinbelow, examples and comparative Examples of the present disclosure are described. However, the present disclosure is not limited to the following examples.

### EXAMPLES

### Example 1: Preparation of Lithium Metal Battery

### Interlayer-Forming Composition

Carbon black CB35 (Asahi Co.) powder was added to a mixture of water and a water-soluble binder, polyvinyl alcohol-grafted polyacrylic acid (PVA-g-10PAA), and the resulting mixture was stirred with a mixer (Thinky Corporation AR-100) to prepare an interlayer-forming composition. PVA-g-10PAA was synthesized by graft-polymerizing an acrylic acid monomer onto a polyvinyl alcohol backbone in accordance with the method described in J. He and L. Zhang, Journal of Alloys and Compounds 763 (2018) 228-240.

Solid Electrolyte Layer Formed with Interlayer A solid electrolyte pellet of Li_{6.5}La₃Zr_{1.5}Ta_{0.5}O₁₂(LLZTO, Toshima Co.) with a thickness of 500 μm and a diameter of 14 mm was prepared. The LLZTO solid electrolyte was subjected to a first acid treatment in 1.5 M hydrochloric acid at 40° C. for 7 minutes, then washed with ethanol. Next, the LLZTO solid electrolyte that had undergone the first acid treatment was subjected to a second acid treatment in 1.0 M phosphoric acid at 40° C. for 30 seconds, then washed with ethanol to form a solid electrolyte layer having pores on its surface.

The prepared interlayer-forming composition was applied to the first surface of the porous solid electrolyte layer and dried at room temperature for 20 minutes, thereby forming a solid electrolyte layer having an interlayer with a thickness of about 7 μm. Based on the total weight of the interlayer, the composition of the interlayer included 95 wt % of carbon black and 5 wt % of polyvinyl alcohol-grafted polyacrylic acid. The area of the interlayer applied to the first surface of the solid electrolyte layer was 0.636 square centimeters (cm²), which corresponds to about 41% of the total surface area of the solid electrolyte layer.

Solid Electrolyte Layer with Electrolyte at Edge Portion

A small amount of liquid electrolyte was gently applied to soak the edge portion of the solid electrolyte layer where no interlayer had been formed, producing a solid electrolyte layer in which the liquid electrolyte was located at the edge portion. The composition of the liquid electrolyte was N-methyl-N-propyl-pyrrolidinium(fluorosulfonyl)imide (Pyrr1,3-FSI, 99.9%, water content<20 parts per million (ppm), Kanto Chemical Co. Inc.) and 2.0 M lithium bis(fluorosulfonyl)imide (LiFSI, 99.9%, water content <10 ppm).

### Anode Layer

On the surface of the solid electrolyte layer formed with the interlayer, a copper foil (Honjo Metal Co., Ltd.) measuring 1.54 cm² in area and 10 μm in thickness was placed, and a 20 μm-thick lithium metal was then placed on the copper foil, followed by housing in an anode case. At this time, the interlayer occupied about 41% of the total area of the anode layer.

### Cathode Layer

LiCoO₂ (LCO, Samsung SDI) was prepared as the cathode active material. Carbon black (Super P® Li, Imerys Co.) was used as the conductive material. Polyvinylidene fluoride (Solef®5130, Solvay Co.) was used as the binder. The binder was employed as a 5 wt % solution in NMP. These materials were then mixed at a weight ratio of 97.6:1.2:1.2 (cathode active material:conductive material:binder) to prepare a cathode active material layer-forming composition. Using an applicator, the cathode active material layer-forming composition was applied onto a 9 μm-thick aluminum foil (Nippon Foil Mfg. Co., LTD) current collector at a loading level of 4.22 grams per cubic centimeter (g/cc) and a thickness of 46 μm. dried at 120° C. for 12 hours, and then compressed to form a cathode active material layer.

The cathode active material layer was then impregnated with a small amount of a catholyte. The catholyte was prepared by mixing 2.0 M lithium bis(fluorosulfonyl)imide (LiFSI, 99.9%, moisture content<10 ppm) with an ionic liquid, 1-ethyl-3-methylimidazolium bis(fluorosulfonyl)imide (EMIM-FSI, 99.9%, moisture content<20 ppm, Kanto Chemical Co. Inc.).

### Lithium Metal Battery

The prepared anode layer/interlayer/solid electrolyte layer/cathode layer was assembled in accordance with a standard CR2032 type coin cell configuration. After compression, the coin cell was preheated at 60° C. for 20 hours.

### Example 2: Preparation of Lithium Metal Battery

A lithium metal battery was prepared in the same manner as in Example 1, except that the anode layer was prepared by placing a 20 μm-thick lithium metal layer on a 10 μm-thick copper foil (Honjo Metal Co., Ltd.) having an area of 0.95 cm² on the surface of the solid electrolyte layer with the interlayer formed thereon, and then housing the resulting assembly in an anode case. At this time, the interlayer occupied about 67% of the total area of the anode layer.

### Comparative Example 1: Preparation of Lithium Metal Battery

A lithium metal battery was prepared in the same manner as in Example 1, except that the edge portion of the solid electrolyte layer where the interlayer was not formed was not soaked with the liquid electrolyte, thereby preparing a solid electrolyte layer that does not include an electrolyte at the edge portion.

### Evaluation Example 1: Electrochemical Impedance (EIS) Test

For the lithium metal batteries prepared in Examples 1 and 2, and Comparative Example 1, an electrochemical impedance test was performed to measure the charge-transfer resistance (R_{ct}). The results are shown in Table 1.

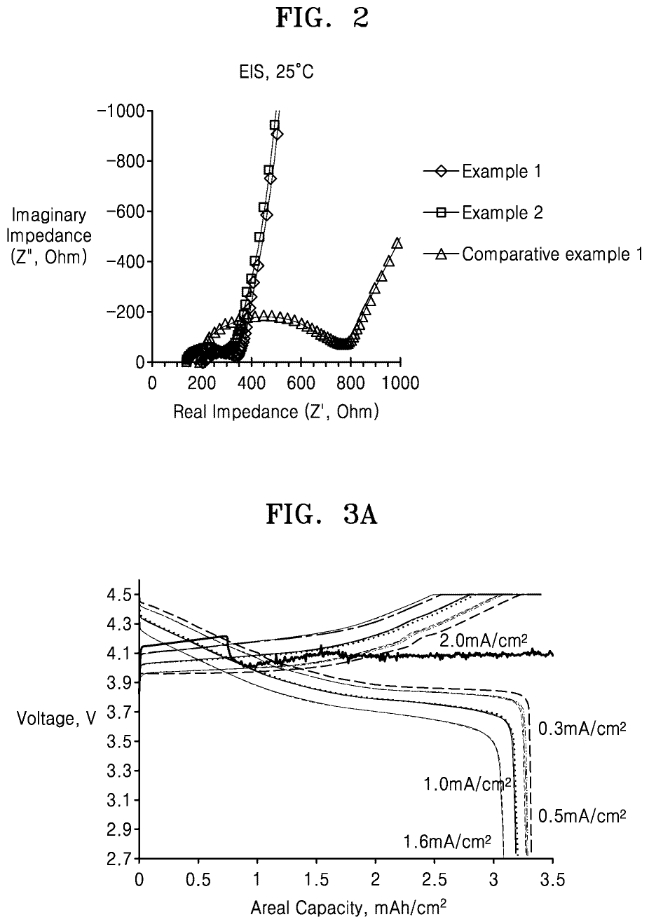

The electrochemical impedance test was performed using an impedance analyzer (Solartron 1400A/1455A) to measure the impedance of each lithium metal battery by a 2-probe method, and a Nyquist plot of the resulting data is shown in FIG. 2. From this plot, the electrolyte resistance (Rₛ, left end), the SEI resistance (R_{SEI}, semi-circle) formed on the electrode surface, and the charge-transfer resistance (R_{CT}, right end) were obtained. The frequency range was 0.1 hertz (Hz) to 1 megahertz (MHz), and the amplitude voltage was 10 millivolts (mV). The measurement was performed in air at 25° C.

TABLE 1

| Item | Charge transfer resistance (R_{ct}, Ω) |
|---|---|
| Example 1 | 130 |
| Example 2 | 160 |
| Comparative Example 1 | 587 |

Referring to Table 1 and FIG. 2, the lithium metal batteries of Examples 1 and 2, which include electrolyte at the edge portion between the anode layer and the solid electrolyte layer, exhibited lower charge-transfer resistance compared to the lithium metal battery of Comparative Example 1, which does not include electrolyte at that edge portion.

Accordingly, it was confirmed that adopting a solid electrolyte layer including an electrolyte at the edge portion between the anode layer and the solid electrolyte layer reduces the charge-transfer resistance between the solid electrolyte layer and the anode in the lithium metal batteries of Examples 1 and 2.

### Evaluation Example 2: Charge-Discharge Test

### (1) Open-Circuit Voltage (OCV)

Prior to the charge-discharge test, the open-circuit voltage (OCV) was measured for the lithium metal batteries prepared in Examples 1 and 2, and Comparative Example 1. The results are shown in Table 2.

TABLE 2

| Item | OCV(V) |
|---|---|
| Example 1 | 3.372 |
| Example 2 | 3.344 |
| Comparative Example 1 | 3.398 |

Referring to Table 2, the OCVs of the lithium metal batteries prepared in Examples 1 and 2 were lower than that of the lithium metal battery of Comparative Example 1. From this result, it was confirmed that the lithium metal batteries prepared in Example 1 and Example 2 can secure the stability of lithium-ion intercalation and deintercalation.

### Evaluation Example 3: Charge-Discharge Test

### (1) Critical Current Density (CCD)

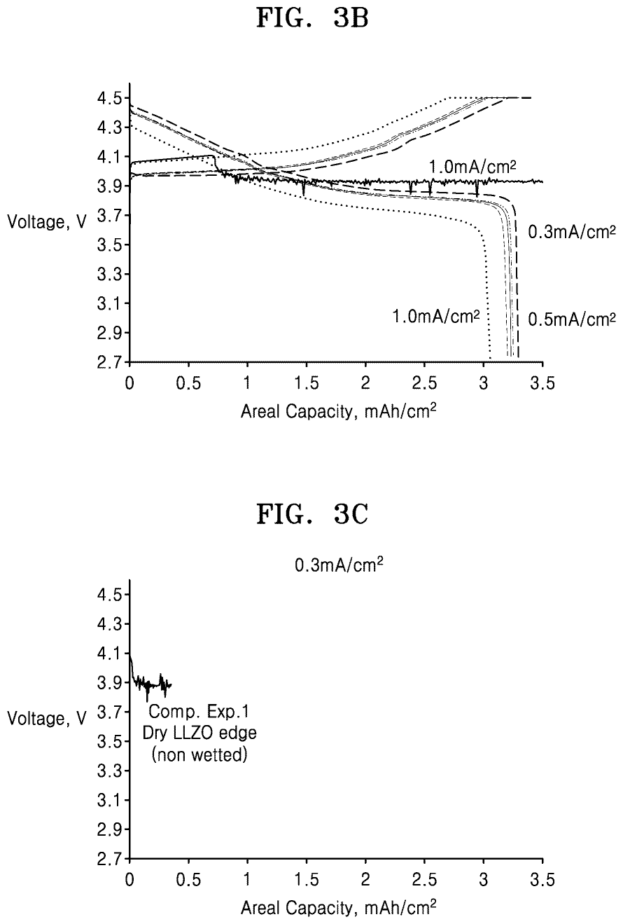

The current density characteristics of the lithium metal batteries prepared in Examples 1 and 2 and Comparative Example 1 were evaluated by the following charge-discharge test, and the results are shown in Table 3 and FIGS. 3A, 3B, and 3C. The charge-discharge test was performed by placing each lithium metal battery in a constant temperature chamber maintained at 25° C.

From the 1^{st} cycle to the 16^{th} cycle, the current density was increased incrementally while performing charge-discharge cycles. The critical current density (CCD) was considered to be the current density in the cycle immediately preceding the cycle in which a short-circuit occurred.

During the 1^{st} cycle, charging was carried out at a constant current of 0.3 milliampere per square centimeter (mA/cm²) until the cell voltage reached 4.5V, followed by discharging at a constant current of 0.3 mA/cm² until the cell voltage reached 2.75 V.

From the 2^{nd} cycle to the 4th cycle, charging was carried out at a constant current of 0.5 mA/cm² until the cell voltage reached 4.5V, followed by discharging at a constant current of 0.5 mA/cm² until the cell voltage reached 2.75 V.

From the 5^{th} cycle to the 7^{th} cycle, charging was carried out at a constant current of 1.0 mA/cm² until the cell voltage reached 4.5V, followed by discharging at a constant current of 1.0 mA/cm² until the cell voltage reached 2.75 V.

From the 8^{th} cycle to the 10^{th} cycle, charging was carried out at a constant current of 1.6 mA/cm² until the cell voltage reached 4.5V, followed by discharging at a constant current of 1.6 mA/cm² until the cell voltage reached 2.75 V.

From the 11^{th} cycle to the 13^{th} cycle, charging was carried out at a constant current of 2.0 mA/cm² until the cell voltage reached 4.5V, followed by discharging at a constant current of 2.0 mA/cm² until the cell voltage reached 2.75 V.

From the 14^{th} cycle to the 16^{th} cycle, charging was carried out at a constant current of 2.5 mA/cm² until the cell voltage reached 4.5V, followed by discharging at a constant current of 2.5 mA/cm² until the cell voltage reached 2.75 V.

During every charge-discharge cycle, a rest period of one minute was provided after each charge-discharge cycle.

Among these cycles, Table 3 presents the areal capacity results at a current density of 0.32 C-rate (1.0 mA/cm²) are shown in Table 3.

TABLE 3

| | | | Areal Capacity |
|---|---|---|---|
| | CCD | Cycle Immediately Before | (mAh/cm²) @ |
| Item | (mA/cm²) | Short-Circuit Occurrence | 0.32 C, 25° C. |
| Example 1 | 2.0 | 11 | 3.18 |
| Example 2 | 1.0 | 6 | 3.05 |
| Comparative | <0.3 | — | — |
| Example 1 | | | |

Referring to Table 3 and FIGS. 3A, 3B, and 3C, the lithium metal batteries of Examples 1 and 2, which include electrolyte at the edge portion between the anode layer and the solid electrolyte layer, exhibited a high critical current density (CCD) as well as a high areal capacity of at least 3.05 mAh/cm².

In contrast, the lithium metal battery of Comparative Example 1, which does not include an electrolyte at the edge portion between the anode layer and the solid electrolyte layer, undergone a short circuit.

A lithium metal battery according to an aspect includes an anode layer, a solid electrolyte layer, and a cathode layer. The lithium metal battery further includes, between the anode layer and the solid electrolyte layer, an interlayer-containing region and an interlayer-free region. The interlayer-containing region includes an interlayer including a carbon-containing material, and at least a portion of the interlayer-free region includes at least one of a liquid electrolyte, a gel electrolyte, or a polymer electrolyte. The lithium metal battery may have low charge transfer resistance between the solid electrolyte layer and the anode layer, and improved critical current density and areal capacity.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A lithium metal battery, comprising:
an anode layer including lithium metal or a lithium alloy;
a solid electrolyte layer on the anode layer; and
a cathode layer on the solid electrolyte layer, and
further comprising, an interlayer-containing region and an interlayer-free region between the anode layer and the solid electrolyte layer,
wherein the interlayer-containing region comprises an interlayer comprising a carbon-containing material, and
at least a portion of the interlayer-free region comprises at least one of a liquid electrolyte, a gel electrolyte, or a polymer electrolyte.

2. The lithium metal battery of claim 1,
wherein the interlayer-free region is: an edge portion between the anode layer and the solid electrolyte layer; a region where the interlayer is absent, other than the edge portion; or a combination thereof.

3. The lithium metal battery of claim 1,
wherein an area of the interlayer is smaller than an area of the anode layer.

4. The lithium metal battery of claim 1,
wherein an area of the interlayer is about 30% to about 80% based on 100% of a total surface area of the solid electrolyte layer.

5. The lithium metal battery of claim 1,
wherein the interlayer has a thickness of about 1 micrometers to about 30 micrometers.

6. The lithium metal battery of claim 1,
wherein the interlayer-free region comprises lithium cations.

7. The lithium metal battery of claim 1,
wherein during charging or discharging of the lithium metal battery, a lithium-containing layer is present at some or all of an interface between the interlayer and the solid electrolyte layer.

8. The lithium metal battery of claim 1,
wherein the carbon-containing material is a carbon material, a carbon composite, or a combination thereof; and a binder.

9. The lithium metal battery of claim 1,
wherein a surface of the solid electrolyte layer comprises pores, and some or all of the pores on the surface of the solid electrolyte layer are filled with the carbon-containing material of the interlayer.

10. The lithium metal battery of claim 1,
wherein the liquid electrolyte and the gel electrolyte comprise an ionic liquid compound and a lithium salt,
wherein the ionic liquid compound comprises: i) one or more cations of ammonium-type, pyrrolidinium-type, pyridinium-type, pyrimidinium-type, imidazolium-type, piperidinium-type, pyrazolium-type, oxazolium-type, pyridazinium-type, phosphonium-type, sulfonium-type, triazolium-type, or a combination thereof; and ii) one or more anions of BF₄, PF₆—, AsF₆—, SbF₆—, AlCl₄, HSO₄, ClO₄, CH₃SO₃—, CF₃CO₂—, (CF₃SO₂)₂N—, Cl—, Br—, I—, BF₄—, SO₄, PF₆—, ClO₄, CF₃SO₃—, CF₃CO₂—, (C₂F₅SO₂)₂N—, (C₂F₅SO₂)(CF₃SO₂)N—, NO₃—, Al₂Cl₇—, AsF₆—, SbF₆—, CF₃COO—, CH₃COO—, CF₃SO₃—, (CF₃SO₂)₃C—, (CF₃CF₂SO₂)₂N—, (CF₃)₂PF₄—, (CF₃)₃PF₃—, (CF₃)₄PF₂—, (CF₃)₅PF—, (CF₃)₆P—, SF₅CF₂SO₃—, SF₅CHFCF₂SO₃—, CF₃CF₂(CF₃)₂CO—, (CF₃SO₂)₂CH—, (SF₅)₃C—, (O(CF₃)₂C₂(CF₃)₂O)₂PO—, or (CF₃SO₂)₂N—, or a combination thereof.

11. The lithium metal battery of claim 1,
wherein the polymer electrolyte comprises: a polymer or copolymer comprising an ion-conductive repeating unit; and a lithium salt, and
wherein the ion-conductive repeating unit comprises an ether-containing monomer, an acrylic monomer, a methacrylic monomer, a siloxane-containing monomer, or a combination thereof.

12. The lithium metal battery of claim 10 or 11,
wherein the lithium salt has a concentration in a range of about 0.1 molar to about 5 molar, and comprises at least one of LiPF₆, LiBF₄, LiCF₃SO₃, Li(CF₃SO₂)₂N, Li(CF₃SO₂)₃C, LiC₂F₅SO₃, Li(FSO₂)₂N, LiC₄F₉SO₃, LiN(SO₂CF₂CF₃)₂, LiN(CN)₂, or a compound represented by Formulas 11 to 14:

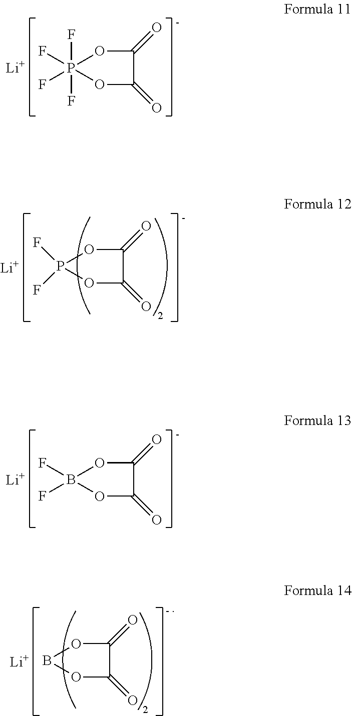

13. The lithium metal battery of claim 1,
wherein the solid electrolyte layer is an oxide-containing solid electrolyte, a polymer solid electrolyte, a polymer-inorganic hybrid electrolyte, an organic-inorganic hybrid polymer electrolyte, or a combination thereof, and
the oxide-containing solid electrolyte is at least one of Garnet-type ceramics Li₃₊ₓLa₃M₂O₁₂ (M=Te, Nb, or Zr) (where x is an integer from 1 to 10), Li_{1+x+y}AlₓTi₂₋ₓSi_{y}P_{3-y}O₁₂ (0<x<2 and 0<y<3), lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0<x<2, 0<y<1, 0<z<3), Li_{1+x+y}(Al, Ga)ₓ(Ti, Ge)₂₋ₓSi_{y}P_{3-y}O₁₂ (0≤x≤51, 0≤y≤1), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride-containing glass (LiₓN_{y}, 0<x<4, 0<y<2), SiS₂ (LiₓSi_{y}S_{z}, 0<x<3, 0<y<2, 0<z<4), P₂S₅-containing glass (LiₓP_{y}S_{z}, 0<x<3, 0<y<3, and 0<z<7), Li₂O, LiF, LiOH, Li₂CO₃, LiAlO₂, Li₂O—Al₂O₃—SiO₂—P₂O₅—TiO₂—GeO₂ ceramics, and LiBSiO, or a combination thereof.

14. The lithium metal battery of claim 1,
wherein the cathode layer comprises a cathode active material and a catholyte,
wherein the catholyte comprises an ionic liquid compound and a lithium salt, and has a viscosity of about 50 centipoises to about 500 centipoises.

15. The lithium metal battery of claim 1,
wherein, at 25° C., a charge-transfer resistance measured by electrochemical impedance analysis is in a range of about 240 ohms to about 200 ohms.

16. A method of preparing a lithium metal battery, the method comprising:
mixing, with a binder, at least one carbon-containing material comprising a carbon material, a carbon composite, or a combination thereof, to prepare an interlayer-forming composition;
applying and drying the interlayer-forming composition on a first surface of a solid electrolyte, at a coverage of about 30% to about 99.9% based on a total surface area of the first surface, thereby forming an interlayer on the surface of the electrolyte layer;
contacting at least one of a liquid electrolyte, a gel electrolyte, or a polymer electrolyte with a surface of the solid electrolyte layer on which the interlayer is not formed;
placing an anode layer on the first surface of the solid electrolyte layer on which the interlayer formed and on the surface of the solid electrolyte layer in contact with the at least one of the liquid electrolyte, the gel electrolyte, or the polymer electrolyte; and
placing a cathode layer on a second surface of the solid electrolyte layer on which the anode layer placed, to prepare the lithium metal battery.

17. The method of claim 16, further comprising
performing a surface treatment on the first surface of the solid electrolyte prior to applying and drying the interlayer-forming composition on the first surface of the solid electrolyte,
wherein the surface treatment comprises chemical treatment, electrolytic polishing, wet polishing, argon plasma etching, oxygen plasma cleaning, annealing, exposure to high vacuum, or a combination thereof.

18. The method of claim 16,
wherein natural pre-lithiation occurs at: an edge portion between the anode layer and the solid electrolyte layer; a region where the interlayer is absent, other than the edge portion; or a combination thereof.

19. The method of claim 16,
wherein, during charging or discharging of the lithium metal battery, a lithium plating layer corresponding to a reduction potential is formed at some or all of an interface between the interlayer and the solid electrolyte layer.

20. A lithium metal battery module comprising a lithium metal battery as a unit cell, the lithium metal battery module comprising:
an anode layer comprising lithium metal or a lithium alloy;
a solid electrolyte layer on the anode layer; and
a cathode layer on the solid electrolyte layer,
further comprising an interlayer-containing region and an interlayer-free region between the anode layer and the solid electrolyte layer,
wherein the interlayer-containing region comprises an interlayer comprising a carbon-containing material, and at least a portion of the interlayer-free region comprises at least one of a liquid electrolyte, a gel electrolyte, or a polymer electrolyte.
